(19) United States
(12) Patent Application Publication
(10) Pub. No.: US 2026/0213636 A1
(43) Pub. Date: Jul. 23, 2026

(54) DC-DC CONVERTER

(71) Applicant: Nuvoton Technology Corporation Japan, Kyoto (JP)

(72) Inventors: Naoki KAWAMOTO, Kyoto (JP); Takashi RYU, Kyoto (JP); Takuya ISHII, Kyoto (JP); Tetsuya MIHASHI, Kyoto (JP); Koji SUZUKI, Kyoto (JP)

(21) Appl. No.: 19/572,103

(22) Filed: Mar. 19, 2026

Related U.S. Application Data
(63) Continuation of application No. PCT/JP2024/034238, filed on Sep. 25, 2024.

(30) Foreign Application Priority Data
Sep. 27, 2023 (JP) 2023-165215

(51) Int. Cl. H02M 1/00; H02M 1/08; H02M 3/158

(52) U.S. Cl. CPC H02M 1/0009; H02M 1/0025; H02M 1/08; H02M 3/158

(57) ABSTRACT

A DC-DC converter that includes: a high-side switch; a low-side switch; an inductor; an output capacitor; and a controller. In the DC-DC converter, the controller includes: a pre-charge circuit that charges the output capacitor; a negative current detection circuit that outputs a negative current detection signal indicating that current flowing from the inductor to the low-side switch has reached a predetermined value; and a control circuit that performs a switching operation that alternately turns on the high-side switch and the low-side switch, and the control circuit starts the switching operation by turning on the low-side switch, and turns off the low-side switch after receiving the negative current detection signal.

### CROSS REFERENCE TO RELATED APPLICATIONS

This is a continuation application of PCT International Patent Application No. PCT/JP 2024/034238 filed on Sep. 25, 2024, designating the United States of America, which is based on and claims priority of Japanese Patent Application No. 2023-165215 filed on Sep. 27, 2023. The entire disclosures of the above-identified applications, including the specifications, drawings and claims are incorporated herein by reference in their entirety.

### FIELD

The present disclosure relates to a DC-DC converter.

### BACKGROUND

DC-DC converters that step down an input direct current (DC) voltage to output an output DC voltage as illustrated in FIG. 5A or FIG. 5B are generally used.

FIG. 5A and FIG. 5B are circuit diagrams each illustrating a configuration of a general DC-DC converter.

FIG. 5A illustrates a DC-DC converter including main switching element 11, freewheeling diode 13, inductor 3, output capacitor 4, and control circuit 5 In FIG. 5A, input DC voltage Ei from input power supply 1 is intermittently output to inductor 3 and output capacitor 4 by the switching operation of main switching element 11, averaged by inductor 3 and output capacitor 4, and supplied as output DC voltage Eo from output capacitor 4 to the load. When the proportion of the on-time of main switching element 11 to the switching period is time ratio δ, the relationship of (Expression 1) indicated below is substantially satisfied between input DC voltage Ei and output DC voltage Eo in a steady state.
Eo=δ·Ei (Expression 1)

The DC-DC converter, under normal conditions, stabilizes output DC voltage Eo as a result of monitoring output DC voltage Eo to adjust time ratio δ by control circuit 5. As one example of such a DC-DC converter, Patent Literature (PTL) 1 discloses a DC-DC converter which includes, in place of freewheeling diode 13, switching element 12 including a body diode as with main switching element 11, to enable an inductor current to flow in the reverse direction, as illustrated in FIG. 5B. In the present disclosure, based on the DC-DC converter illustrated in FIG. 5B as a fundamental configuration, the main switching element which is connected to the input high potential side is hereinafter referred to as a high-side switch, and the switching element which is connected to the low potential side, and with which the freewheeling diode was replaced is hereinafter referred to as a low-side switch.

Replacing a diode with a switching element is referred to as synchronous rectification, and it is possible to reduce a conduction loss by setting the conduction voltage when the low-side switch is on (i.e., when the high-side switch is off) lower than the forward voltage of the diode. In addition, when the inductor current flows in reverse, the high-side switch turns on at the zero voltage in conjunction with the turn-off operation of the low-side switch, and thus it is possible to reduce a switching loss.

When input DC voltage Ei is significantly higher (for example, 10 times or more) than output DC voltage Eo, the on-time of the high-side switch becomes short. For this reason, it is difficult to respond to an increase in output DC voltage Eo due to a sudden reduction in load or the like by adjusting the on-time which is already short to be even shorter. In view of the above, as in PTL 2, a control method of adjusting the off-time with the on-time being fixed.

For example, by reducing the switching loss as a result of constantly switching the high-side switch and the low-side switch alternately to cause the inductor current to flow in reverse as in PTL 1, and further, by fixing the on-time of the high-side switch as in PTL 2, a DC-DC converter suitable for high-input specifications can be obtained.

### Citation List

### Patent Literature

PTL 1: Japanese Unexamined Patent Application Publication No. 09-028076

PTL 2: U.S. Pat. No. 10,587,196

### SUMMARY

### Technical Problem

In the designing of a DC-DC converter, there are instances where the shapes of components are constrained due to demands for downsizing, and the fact that the shape of an inductor is constrained means that the inductance of the inductor is constrained. In the case where the inductance of an inductor is small, an amount of increase in current when the high-side switch is on and the input DC voltage is high becomes large, and thus an allowable current value of the inductor is limited. For this reason, it is necessary to suppress the maximum current value of the inductor. Note that, as in PTL 2, by fixing the on-time to a short time, the maximum current value can be suppressed, but when the input DC voltage is large, there are instances where it is difficult to fix the on-time to an even shorter time, leading to a problem that it is difficult to suppress the maximum current value of the inductor.

The present disclosure provides a DC-DC converter capable of suppressing the maximum current value of an inductor even when the inductance of the inductor is small.

### Solution to Problem

A DC-DC converter according to one aspect of the present disclosure is a DC-DC converter that includes: a high-side switch; a low-side switch; an inductor; an output capacitor; and a controller. The DC-DC converter steps down an input direct current (DC) voltage from an input power supply to output an output DC voltage from the output capacitor. In the DC-DC converter, the controller includes: a pre-charge circuit that charges the output capacitor; a negative current detection circuit that outputs a negative current detection signal indicating that current flowing from the inductor to the low-side switch has reached a predetermined value; and a control circuit that performs a switching operation that alternately turns on the high-side switch and the low-side switch, and the control circuit starts the switching operation by turning on the low-side switch, and turns off the low-side switch after receiving the negative current detection signal.

General and specific aspects described above may be implemented using a system, a method, an integrated circuit, a computer program, or a computer-readable recording medium such as a compact disc read only memory (CD-ROM), or any combination of systems, methods, integrated circuits, computer programs, or computer-readable recording media.

### Advantageous Effects

With the DC-DC converter according to the present disclosure, it is possible to suppress the maximum current value of an inductor even when the inductance of the inductor is small.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a circuit diagram illustrating a configuration of a DC-DC converter according to Embodiment 1.

FIG. 2 is a flowchart illustrating an operation of the DC-DC converter according to Embodiment 1.

FIG. 3 is a waveform diagram illustrating the operation of the DC-DC converter according to Embodiment 1.

FIG. 4 is a circuit diagram illustrating a configuration of a DC-DC converter according to Embodiment 2.

FIG. 5A is a circuit diagram illustrating a configuration of a general DC-DC converter.

FIG. 5B is a circuit diagram illustrating a configuration of a general DC-DC converter.

### DESCRIPTION OF EMBODIMENTS

Hereinafter, embodiments of the present disclosure will be described with reference to the Drawings. It should be noted that each of the exemplary embodiments described below shows one specific example of the present disclosure. The numerical values, shapes, materials, structural components, the arrangement and connection of the structural components, steps, the processing order of the steps etc. described in the following embodiments are mere examples, and therefore do not limit the scope of the present disclosure. In addition, the respective diagrams are not necessarily precise illustrations. In each of the diagrams, substantially the same structural components are assigned with the same reference signs, and there are instances where redundant descriptions will be omitted or simplified. In addition, “connection” means electrical connection, and includes not only the case where two circuit elements are directly connected, but also the case where two circuit elements are indirectly connected with another circuit element inserted between the two circuit elements.

In addition, “proportional” described below may be “substantially proportional”, and “inversely proportional” may be “substantially inversely proportional”. For example, when the coefficient in the case where y is proportional to x is denoted as “a”, substantially proportional and substantially inversely proportional mean that “a” does not necessarily have to be a fixed value depending on the value of x, and “a” may vary somewhat depending on the value of x. For example, the variation range of a is within ±10% with respect to a representative value (such as an average value, a median value, or a mode value) of the values that a can take.

### Embodiment 1

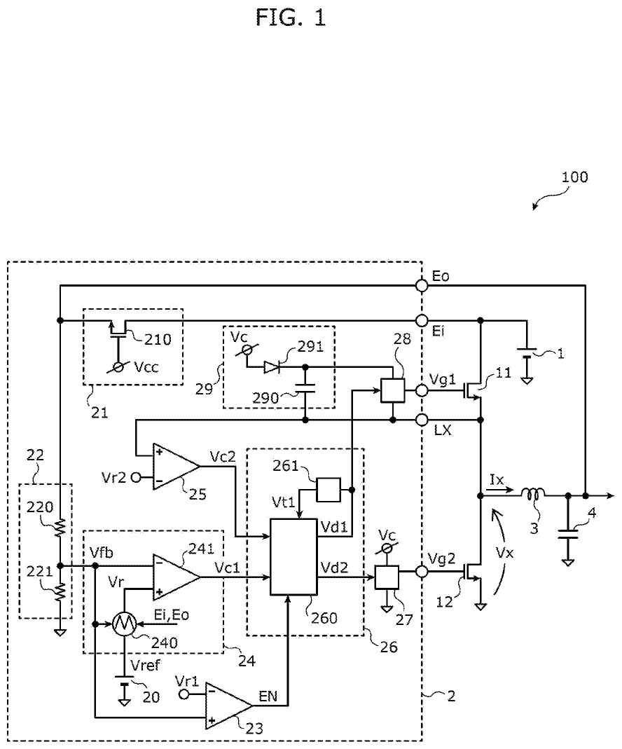

FIG. 1 is a circuit diagram illustrating a configuration of DC-DC converter 100 according to Embodiment 1.

DC-DC converter 100 includes high-side switch 11, low-side switch 12, inductor 3, output capacitor 4, and controller 2, and steps down an input DC voltage from input power supply 1 to output an output DC voltage from output capacitor 4. In FIG. 1, DC-DC converter 100 is a buck converter that steps down input DC voltage Ei from input power supply 1 such as a battery, and supplies output DC voltage Eo to a load (not illustrated). In DC-DC converter 100, a series configuration of high-side switch 11 and low-side switch 12 is connected in parallel with input power supply 1, one end of inductor 3 with inductance L is connected to connection point LX of high-side switch 11 and low-side switch 12, and output capacitor 4 is connected to the other end of inductor 3. A voltage across both ends of output capacitor 4 is supplied to the load as output DC voltage Eo. High-side switch 11 and low-side switch 12 are, for example, N type metal oxide semiconductor (NMOS) transistors.

Controller 2 includes reference voltage source 20, pre-charge circuit 21, feedback circuit 22, activation circuit 23, pseudo ripple comparison circuit 24, negative current detection circuit 25, control circuit 26, low-side drive circuit 27, high-side drive circuit 28, and bootstrap circuit 29. Controller 2 controls the switching operation of high-side switch 11 and low-side switch 12 to stabilize output DC voltage Eo.

Reference voltage source 20 generates reference voltage Vref.

Pre-charge circuit 21 charges output capacitor 4. More specifically, pre-charge circuit 21 includes NMOS transistor 210 that receives activation voltage Vcc at the gate, and charges output capacitor 4 through NMOS transistor 210. NMOS transistor 210 is an example of a transistor connected between input power supply 1 and output capacitor 4. For example, activation voltage Vcc is generated based on reference voltage Vref. In addition, voltages such as first reference voltage Vr1, second reference voltage Vr2, and drive power supply voltage Vc are also generated based on reference voltage Vref.

Feedback circuit 22 divides output DC voltage Eo using resistor 220 and resistor 221, and outputs feedback voltage Vfb.

Activation circuit 23 outputs an enable signal to permit control circuit 26 to perform a switching operation when output DC voltage Eo is at or above a predetermined value. More specifically, activation circuit 23 compares first reference voltage Vr1 and feedback voltage Vfb, and outputs enable signal EN that becomes an H level when feedback voltage Vfb is higher than first reference voltage Vr1. First reference voltage Vr1 is set lower than reference voltage Vref to detect, at activation, that output DC voltage Eo has reached a predetermined level lower than or equal to a target voltage.

Pseudo ripple comparison circuit 24 includes pseudo ripple generation circuit 240 and comparison circuit 241. Pseudo ripple comparison circuit 240 receives input DC voltage Ei, output DC voltage Eo, and feedback voltage Vfb, generates a pseudo ripple voltage, and generates and outputs target voltage Vr obtained by superimposing the pseudo ripple voltage onto the reference voltage Vref. Target voltage Vr decreases at a predetermined rate proportional to an input-output voltage difference (Ei−Eo) from reference voltage Vref during the on-period of high-side switch 11, increases at a predetermined rate proportional to output DC voltage Eo during the on-period of low-side switch 12, and when reaching feedback voltage Vfb, output capacitor 4 is charged to reference voltage Vref. Comparison circuit 241 compares feedback voltage Vfb and target voltage Vr, and outputs first comparison signal Vc1 that becomes an H level when target voltage Vr exceeds feedback voltage Vfb. In this manner, the switching operation can be started by turning on low-side switch 12 when output capacitor 4 is charged to a certain extent.

Negative current detection circuit 25 outputs a negative current detection signal indicating that the current flowing from inductor 3 to low-side switch 12 has reached a predetermined value. For example, negative current detection circuit 25 detects an electric potential at connection point LX between high-side switch 11 and low-side switch 12. More specifically, negative current detection circuit 25 compares LX terminal voltage Vx and second reference voltage Vr2, and when LX terminal voltage Vx exceeds second reference voltage Vr2, outputs second comparison signal Vc2 that becomes an H level. When low-side switch 12 is on, LX terminal voltage Vx is a product of inductor current Ix and on-resistance of low-side switch 12, and thus by comparing LX terminal voltage Vx and second reference voltage Vr2, it is detected that inductor current Ix has reached a predetermined reverse flow value; that is, the current flowing from inductor 3 to low-side switch 12 has reached a predetermined value. For example, second reference voltage Vr2 is set to a voltage value closer to zero than other reference voltages. Second comparison signal Vc2 is an example of a negative current detection signal indicating that current flowing from inductor 3 to low-side switch 12 has reached a predetermined value. Negative current detection circuit 25 outputs second comparison signal Vc2 to control circuit 26.

As described above, by detecting the electric potential at the connection point between high-side switch 11 and low-side switch 12, it is possible to detect to what extent the negative current is flowing, and to turn off low-side switch 12 after the negative current has reached a predetermined value.

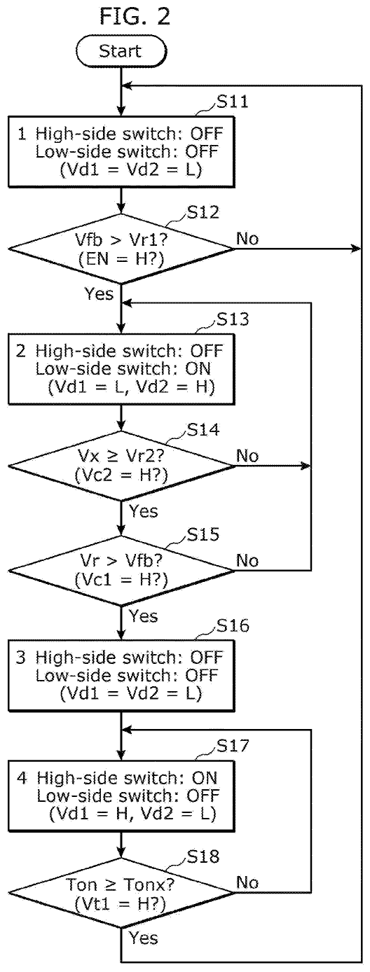

Control circuit 26 performs the switching operation that alternately turning of high-side switch 11 and low-side switch 12. Control circuit 26 includes logic circuit 260 and on-time setting circuit 261, receives enable signal EN, first comparison signal Vc1, second comparison signal Vc2, and on-time setting signal Vt1, and outputs high-side drive signal Vd1 and low-side drive signal Vd2. On-time setting circuit 261 is a timer circuit that outputs on-time setting signal Vt1 that becomes an L level when high-side drive signal Vd1 rises, and becomes an H level after predetermined time Tonx. Although the details of control circuit 26 (specifically, logic circuit 260) will be described later with reference to FIG. 2, control circuit 26 starts the switching operation by turning on low-side switch 12, and turns off low side-switch 12 after receiving second comparison signal Vc2.

Low-side drive circuit 27 is biased by drive power supply voltage Vc, amplifies low-side drive signal Vd2, and outputs drive signal Vg2 for driving low-side switch 12. High-side drive circuit 28 amplifies high-side drive signal Vd1 and outputs drive signal Vg1 for driving high-side switch 11. Hereinafter in the present disclosure, the on/off states of high-side switch 11 are represented by the high/low (H, L) of high-side drive signal Vd1, and the on/off states of low-side switch 12 are represented by the high/low (H, L) of low-side drive signal Vd2.

Bootstrap circuit 29 includes capacitor 290 that supplies high-side drive circuit 28 with a drive power supply voltage, and diode 291 that charges capacitor 290 from the driving power supply of drive power supply voltage Vc. When low-side switch 12 is on, LX terminal voltage Vx is at approximately a zero potential, and thus charging current flows from the drive power supply through diode 291, capacitor 290, connection point LX, to low-side switch 12, in stated order, and capacitor 290 is charged to drive power supply voltage Vc.

FIG. 2 is a flowchart illustrating an operation of DC-DC converter 100 according to Embodiment 1. Specifically, FIG. 2 is a flowchart illustrating an operation of logic circuit 260 included in control circuit 26. In FIG. 2, state 1 to state 4 are indicated as the states of high-side switch 11 and low side switch 12.

State 1 is the state in which high-side drive signal Vd1 and low-side drive signal Vd2 are both at an L level, and both of the switches are in an off state.

State 2 is the state in which high-side drive signal Vd1 is at an L level, low-side drive signal Vd2 is at an H level, high-side switch 11 is in an off state, and low-side switch 12 is in an on state.

State 3 is the state in which high-side drive signal Vd1 and low-side drive signal Vd2 are both at an L level, and both of the switches are in an off state.

State 4 is the state in which high-side drive signal Vd1 is at an H level low-side drive signal Vd2 is at an L level, high-side switch 11 is in an on state, and low-side switch 12 is in an off state.

FIG. 2 indicates the fundamental conditions under which the sates of high-side switch 11 and low-side switch 12 transition through state 1, state 2, state 3, state 4, state 1, . . . .

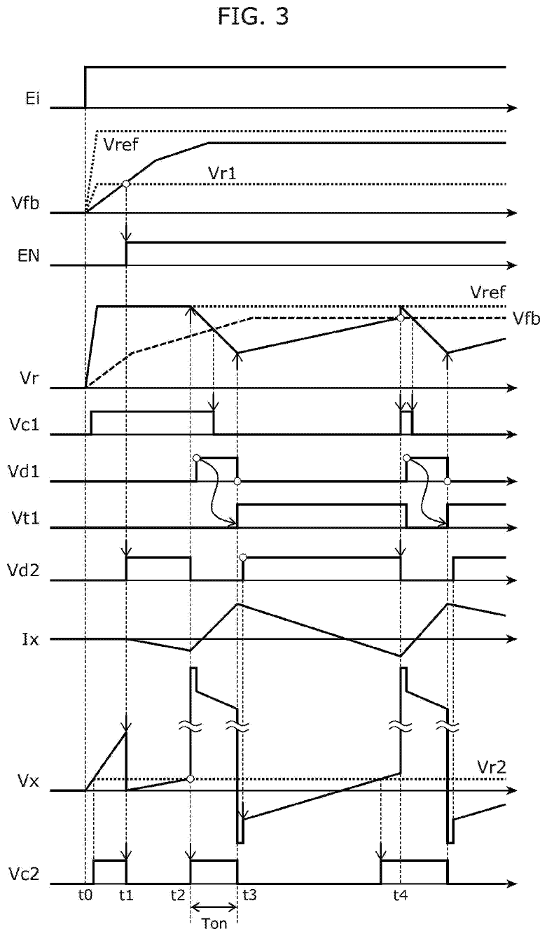

FIG. 3 is a waveform diagram illustrating the operation of DC-DC converter 100 according to Embodiment 1. FIG. 3 is a waveform diagram for each main section of DC-DC converter 100 of Embodiment 1, and shows, from the top: input DC voltage Ei; feedback voltage Vfb, reference voltage Vref, and first reference voltage Vr1; enable signal EN; target voltage Vr, feedback voltage Vfb, and reference voltage Vref; first comparison signal Vc1; high-side drive signal Vd1; on-time setting signal Vt1; low-side drive signal Vd2; inductor current Ix; LX terminal voltage Vx and second reference voltage Vr2; and second comparison signal Vc2. Hereinafter, the operation of DC-DC converter 100 (specifically, the operation of control circuit 26) according to Embodiment 1 illustrated in FIG. 1 will be described with reference to FIG. 2 and FIG. 3.

At time t0 in FIG. 3, when input DC voltage Ei rises, reference voltages and power supply voltage rise in controller 2, and each circuit becomes operable. In FIG. 2, in step S11, high-side switch 11 and low-side switch 12 are off (Vd1=Vd2=L), which is state 1. Subsequently, since output capacitor 4 is charged by pre-charge circuit 21, feedback voltage Vfb increases together with output DC voltage Eo. During this increase of feedback voltage Vfb, a period in which target voltage Vr >feedback voltage Vfb is generated. However, since enable signal EN is at the L level, the states of high-side switch 11 and low-side switch 12 do not transition, and until feedback voltage Vfb reaches first reference voltage Vr1, step S12 results in No, high-side switch 11 and low-side switch 12 both remain in the off state, and LX terminal voltage Vx increases together with output DC voltage Eo.

At time t1, when feedback voltage Vfb reaches first reference voltage Vr1; that is, when step S12 results in Yes, enable signal EN becomes the H level. As a result, in step S13, logic circuit 260 causes low-side drive signal Vd2 to rise (Vd2=H) to cause high-side switch 11 and low-side switch 12 to transition to state 2, and low-side switch 12 turns on. At this time, logic circuit 260 maintains high-side drive signal Vd1 at the L level (Vd1=L), and high-side switch 11 remains in the off state. As a result of tuning on of low-side switch 12, LX terminal voltage Vx becomes zero, output DC voltage Eo is applied to inductor 3, and inductor current Ix flows through output capacitor 4, inductor 3, and low-side switch 12, in stated order. This current increases in a negative direction with a slope of Eo/L. As low-side switch 12 turns on, pseudo ripple generation circuit 240 attempts to increase target voltage Vr at a constant rate, but target voltage Vr is clamped to reference voltage Vref and is higher than feedback voltage Vfb which is increasing, and first comparison signal Vc1 is at the H level.

Until LX terminal voltage Vx reaches second reference voltage Vr2, step S14 results in No, and state 2 is maintained. At time t2, when LX terminal voltage Vx reaches second reference voltage Vr2 due to inductor current Ix which increases in the negative direction; that is, when step S14 results in Yes, second comparison signal Vc2 becomes the H level (Vc2 =H). In addition, since target voltage Vr is already higher than feedback voltage Vfb (Vc1=H); that is, since step S15 results in Yes, high-side switch 11 and low-side switch 12 transition to state 3.

In step S16, logic circuit 260 causes low-side drive signal Vd2 to fall cause high-side switch 11 and low-side switch 12 to transition to state 3, and high-side switch 11 and low-side switch 12 are both in the off state (Vd1=Vd2=L) which is state 3. Since inductor current Ix was flowing in the negative direction, LX terminal voltage Vx jumps up due to inertia of inductor 3 and exceeds input DC voltage Ei, and the body diode of high-side switch 11 conducts. This state is a dead time for avoiding simultaneous turning on of the both switches, and high-side switch 11 and low-side switch 12 immediately transition to the next state 4 when there is no anomaly. Pseudo ripple generation circuit 240 causes target voltage Vr to decrease from reference voltage Vref at a constant rate proportional to input-output voltage difference (Ei−Eo).

In step S17, logic circuit 260 causes high-side drive signal Vd1 to rise (Vd1=H), and high-side drive circuit 28 turns on high-side switch 11. At this time, logic circuit 260 maintains low-side drive signal Vd2 at the L level (Vd2=L), and low-side switch 12 remains in the off state. As a result of turning of high-side switch 11, LX terminal voltage Vx becomes input DC voltage Ei, and input-output voltage difference (Ei−Eo) is applied to inductor 3. Inductor current Ix increases from the negative current and becomes the positive current that flows through input power supply 10, high-side switch 11, inductor 3, and output capacitor 4, in stated order, and this positive current increases with a slope of (Ei−Eo)/L.

Until on-time Ton of high-side switch 11 reaches predetermined time Tonx, step S18 results in No, and state 4 is maintained. At time t3, when on-time Ton reaches predetermined time Tonx; that is, when step S18 results in Yes, on-time setting signal Vt1 of on-time setting circuit 261 becomes the H level, high-side switch 11 and low-side switch 12 return to state 1, and high-side switch 11 turns off to be in the off state together with low-side switch 12. Since inductor current Ix was flowing in the positive direction, LX terminal voltage Vx sharply decreases due to inertia of inductor 3, falls below the zero potential, and the body diode of low-side switch 12 conducts. Since enable signal EN is at the H level, logic circuit 260 causes low-side drive signal Vd2 to rise to turn on low-side switch 12 in order to cause high-side switch 11 and low-side switch 12 to immediately transition to the next state 2. Target voltage Vr of pseudo ripple generation circuit 240 turns to increase.

In state 2 subsequent to time t3, inductor current Ix decreases and eventually becomes the negative current, and even when LX terminal voltage Vx exceeds second reference voltage Vr2 and second comparison signal Vc2 becomes the H level, target voltage Vr does not reach feedback voltage Vfb, and state 2 in which low-side switch 12 is on is maintained. In other words, although step S14 results in Yes, step S15 results in No, and thus state 2 is maintained.

At time t4, when target voltage Vr reaches feedback voltage Vfb, output Vc1 of comparison circuit 241 becomes the H level, high-side switch 11 and low-side switch 12 transition to state 4 through state 3, pseudo ripple comparison circuit 24 sets target voltage Vr to reference voltage Vref and then causes target voltage Vr to decrease, and logic circuit 260 causes high-side drive signal Vd1 to rise to turn on high-side switch 11. Subsequently, the operation in which low-side switch 12 is turned on when target voltage Vr increases and high-side switch 11 is turned on when target voltage Vr decreases is repeated.

In the switching operation of DC-DC converter 100 in the steady state, on-time Ton of high-side switch 11 is fixed at predetermined time Tonx set by on-time setting circuit 261, and target voltage Vr decreases from reference voltage Vref at a constant rate proportional to input-output voltage difference (Ei−Eo). As a result, reference voltage Vr1 at time t3 when target voltage Vr turns to increase is expressed by (Expression 2) indicated below, where α is a proportional constant.
Vr1=Vref−α·(Ei−Eo)·Tonx (Expression 2)

Next, since off-time Toff in the steady state is the time for target voltage Vr to reach feedback voltage Vfb from reference voltage Vr1 at a rate proportional to output DC voltage Eo, using the same proportional constant α as for on-time Ton, the relationship of (Expression 3) indicated below is satisfied.
Vfb−Vr1=α·Eo·Toff (Expression 3)

By eliminating Vr1 from (Expression 2) and (Expression 3), the relationship of (Expression 4) indicated below is satisfied.
Vref−Vfb=α·(Ei−Eo)·Tonx−α·Eo·Toff (Expression 4)

Meanwhile, since the increase and decrease of inductor current Ix are balanced, the relationship of (Expression 5) indicated below is satisfied.
(Ei−Eo)·Ton≈Eo·Toff (Expression 5)

Here, the reason for using “≈” is that both sides have a slight difference due to the voltage drop caused by parasitic impedance such as wiring resistance. Based on the expressions from (Expression 2) through (Expression 4), the relationship of (Expression 6) indicated below is satisfied.
Vfb≈Vref (Expression 6)

For example, when the load increases and output DC voltage Eo decreases, feedback voltage Vfb also decreases, and off-time Toff becomes shorter according to (Expression 3), and thus output DC voltage Eo increases. Since such negative feedback acts, feedback voltage Vfb is stabilized at reference voltage Vref. In this manner, control circuit 26 fixes the on-time of high-side switch 11 to a predetermined value and adjusts the off-time, in order to control the output power of DC-DC converter 100. The operation in the steady state described above is an existing control method called a hysteresis control method in which the on-time is fixed, and is suitable for the specifications with high input.

DC-DC converter 100 according to the present disclosure, for example, in order to allow use of an inductor with strict constraints on inductance and current due to requirements for downsizing, suppresses the peak current value at turning off of high-side switch 11 by allowing the inductor current to start flowing from the negative current when high-side switch 11 is on, and the essential points for realizing this are following three points.
Provide pre-charge circuit 21 to cause the output DC voltage to rise in advance.
At the start of the switching operation, turn on low-side switch 12 first.
When low-side switch 12 turns on, maintain the on-state of low-side switch 12 until the current flowing from inductor 3 to low-side switch 12 reaches a predetermined value.

With the above-described three points, when high-side switch 11 is on, the inductor current always starts from the negative current at or below a predetermined value, and since the on-time is set to a predetermined value, it is possible to suppress the peak current.

In addition, when high-side switch 11 is an NMOS transistor as in the present disclosure, bootstrap circuit 29 for driving power supply thereof is required. By turning on low-side switch 12 first at the start of the switching operation, there is also an advantageous effect that bootstrap circuit 29 operates to secure the drive voltage for high-side switch 11.

### Embodiment 2

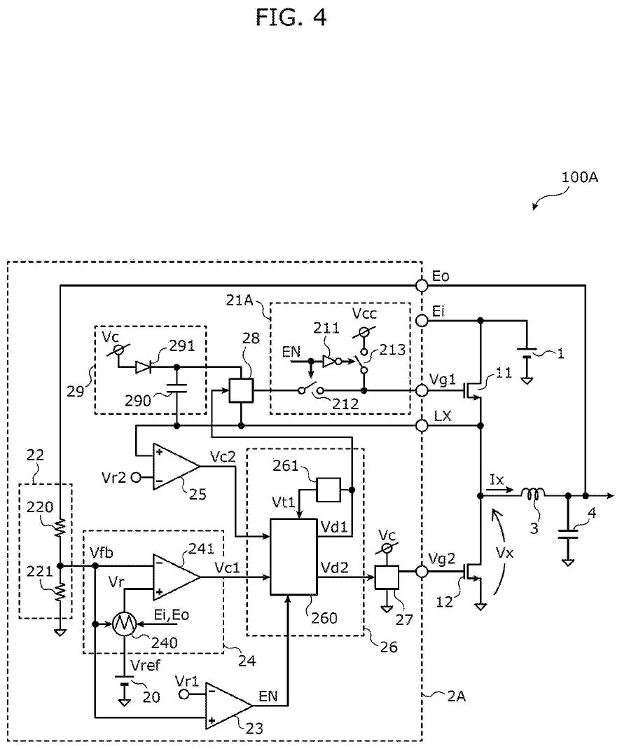

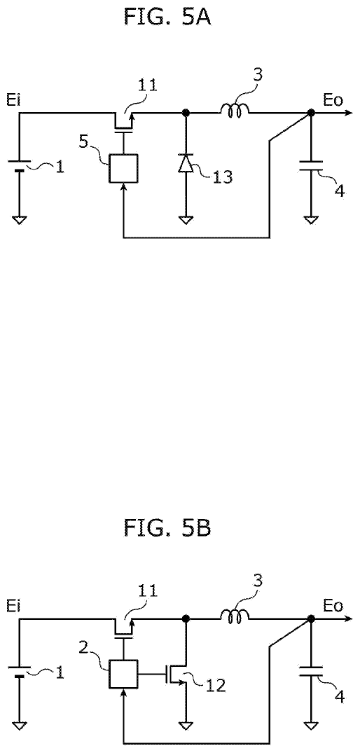

FIG. 4 is a circuit diagram illustrating a configuration of DC-DC converter 100A according to Embodiment 2. In FIG. 4, structural components with similar functions to DC-DC converter 100 illustrated in FIG. 1 are assigned the same reference numerals, and description thereof will be omitted. DC-DC converter 100A according to Embodiment 2 differs from DC-DC converter 100 according to Embodiment 1 illustrated in FIG. 1 is the pre-charge circuit provided in the controller, and to distinguish from FIG. 1, controller 2 is denoted as controller 2A, and pre-charge circuit 21 is denoted as pre-charge circuit 21A.

Pre-charge circuit 21A charges output capacitor 4 through high-side switch 11. More specifically, pre-charge circuit 21A includes inverter 211 that inverts enable signal EN, switch 212 that opens and closes according to enable signal EN and connects high-side drive circuit 28 and the gate of high-side switch 11, and switch 213 that opens and closes according to an inverted signal of enable signal EN and applies activation voltage Vcc to the gate of high-side switch 11.

With this configuration, when enable signal EN is at the H level, switch 212 turns on, switch 213 turns off, drive signal Vg1 from high-side drive circuit 28 is applied to the gate of high-side switch 11, and high-side switch 11 performs the switching operation together with low-side switch 12. When enable signal EN is at the L level; that is, when high-side switch 11 and low-side switch 12 do not perform the switching operation as prior to activation, switch 212 turns off, switch 213 turns on, activation voltage Vcc is applied to the gate of high-side switch 11, and output capacitor 4 is charged through high-side switch 11.

As described above, in Embodiment 2 of the present disclosure, high-side switch 11 also serves the role of NMOS transistor 210 of pre-charge circuit 21 of Embodiment 1. In other words, a dedicated switch for charging output capacitor 4 before the start of the switching operation is unnecessary, and high-side switch 11 can also be used as a switch for charging output capacitor 4. In Embodiment 2, as a result of high-side switch 11 also serving as a switch (transistor) for pre-charging output capacitor 4, it is possible to downsize controller 2A.

### Other Embodiments

Although the DC-DC converter according to the present disclosure has been described based on Embodiments 1 and 2 thus far, the present disclosure is not limited to these embodiments described above. Other forms in which various modifications apparent to those skilled in the art are applied to the embodiments, or other forms structured by combining some of the structural components of the embodiments are also included within the scope of the present disclosure, unless such changes and modifications depart from the scope of the present disclosure.

For example, although the present disclosure has described the case where the on-time is fixed, the on-time that is fixed need not necessarily be an on-time constantly adjusted by a feedback voltage for controlling an output DC voltage, but need only be an on-time fixed to a predetermined value. Since it is difficult to dynamically and finely control a short on-time when the input DC voltage is high, the on-time is fixed to a predetermined value and the off-time is controlled. For example, PTL 2 discloses a technique for setting an on-time to be inversely proportional to an input DC voltage. In addition, although the present disclosure has described an example applied to a hysteresis control method, the present disclosure may be applied to a method that controls an off-time using an error amplifier.

Note that each of the structural components (in particular, the controller) included in the DC-DC converter in the above-described embodiments may be configured in the form of a dedicated hardware product, or may be realized by executing a software program suitable for the structural component. Each of the structural components may be implemented by means of a program executing unit, such as a CPU or a processor, reading and executing the software program recorded on a recording medium such as a hard disk or a semiconductor memory.

Some or all of the functions of the DC-DC converter according to the foregoing embodiments are typically implemented as LSIs which are integrated circuits They may be implemented as a single chip one-by-one, or as a single chip to include some or all thereof. In addition, the integrated circuit is not limited to an LSI, and it may be implemented as a dedicated circuit or a general-purpose processor. A field programmable gate array (FPGA) that is programmable after an LSI is manufactured or a reconfigurable processor that is capable of reconfiguring connection and settings of circuit cells inside an LSI may be employed.

Furthermore, in the future, with advancement in semiconductor technology, a brand-new technology may replace LSI. The structural components included in the DC-DC converter each can be integrated using such a technology.

It should be noted that the present disclosure also includes other forms in which various modifications apparent to those skilled in the art are applied to the embodiments or forms in which structural components and functions in the embodiments are arbitrarily combined within the scope of the present disclosure.

### Others

The descriptions of the embodiments described above disclose the following techniques.
(Technique 1) A DC-DC converter that includes: a high-side switch; a low-side switch; an inductor; an output capacitor; and a controller. The DC-DC converter steps down an input direct current (DC) voltage from an input power supply to output an output DC voltage from the output capacitor. In the DC-DC converter, the controller includes: a pre-charge circuit that charges the output capacitor; a negative current detection circuit that outputs a negative current detection signal indicating that current flowing from the inductor to the low-side switch has reached a predetermined value; and a control circuit that performs a switching operation that alternately turns on the high-side switch and the low-side switch, and the control circuit starts the switching operation by turning on the low-side switch, and turns off the low-side switch after receiving the negative current detection signal.

According to this, by increasing the output DC voltage in advance by the pre-charge circuit before starting a switching operation, and starting the switching operation by turning on of the low-side switch, it is possible to first cause current to flow in reverse from the inductor to the low-side switch; that is, to cause the negative current to flow. Then, since the low-side switch is turned off and the high-side switch is turned on after this current reaches a predetermined value, when the high-side switch is on, the inductor current necessarily becomes a negative current at or below the predetermined value, and the inductor current increases from the negative current. Therefore, compared to the case where the inductor current increases from the state in which the inductor current is zero when the high-side switch is on, it is possible to reduce the maximum current value of the inductor by an amount corresponding to the above-described negative current. As a result, it is possible to suppress the maximum current value of the inductor even when the inductance of the inductor is small. In this manner, with the DC-DC converter according to the present disclosure, for example, it is possible to use an inductor with strict constraints on inductance and current due to requirements for downsizing.
(Technique 2) The DC-DC converter according to Technique 1, in which the pre-charge circuit includes a transistor connected between the input power supply and the output capacitor.

According to this, it is possible to charge the output capacitor through the transistor.
(Technique 3) The DC-DC converter according to Technique 1, in which the pre-charge circuit charges the output capacitor through the high-side switch.

According to this, a dedicated switch for charging the output capacitor before the start of the switching operation is unnecessary, and the high-side switch can also be used as a switch for charging the output capacitor.
(Technique 4) The DC-DC converter according to any one of Techniques 1 to 3, in which the controller further includes an activation circuit that outputs an enable signal to permit the control circuit to perform the switching operation when the output DC voltage is at or above a predetermined value.

According to this, the switching operation can be started by turning on the low-side switch when the output capacitor is charged to a certain extent.
(Technique 5) The DC-DC converter according to any one of Techniques 1 to 4, in which the negative current detection circuit detects an electric potential at a connection point between the high-side switch and the low-side switch.

According to this, by detecting the electric potential at the connection point between the high-side switch and the low-side switch, it is possible to detect to what extent the negative current is flowing, and to turn off the low-side switch after the negative current has reached a predetermined value.
(Technique 6) The DC-DC converter according to any one of Techniques 1 to 5, in which the control circuit fixes an on-time of the high-side switch to a predetermined value and adjusts an off-time of the high-side switch, to control output power of the DC-DC converter.

In this manner, the off-time may be adjusted with the on-time being fixed.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### Industrial Applicability

The DC-DC converter according to the present disclosure can be used as a power supply device that obtains an intended output DC voltage by stepping down from an input DC voltage.

1. A DC-DC converter comprising:
a high-side switch;
a low-side switch;
an inductor;
an output capacitor; and
a controller, wherein
the DC-DC converter steps down an input direct current (DC) voltage from an input power supply to output an output DC voltage from the output capacitor,
the controller includes:
a pre-charge circuit that charges the output capacitor;
a negative current detection circuit that outputs a negative current detection signal indicating that current flowing from the inductor to the low-side switch has reached a predetermined value; and
a control circuit that performs a switching operation that alternately turns on the high-side switch and the low-side switch, and
the control circuit starts the switching operation by turning on the low-side switch, and turns off the low-side switch after receiving the negative current detection signal.

2. The DC-DC converter according to claim 1, wherein
the pre-charge circuit includes a transistor connected between the input power supply and the output capacitor.

3. The DC-DC converter according to claim 1, wherein
the pre-charge circuit charges the output capacitor through the high-side switch.

4. The DC-DC converter according to claim 1, wherein
the controller further includes an activation circuit that outputs an enable signal to permit the control circuit to perform the switching operation when the output DC voltage is at or above a predetermined value.

5. The DC-DC converter according to claim 1, wherein
the negative current detection circuit detects an electric potential at a connection point between the high-side switch and the low-side switch.

6. The DC-DC converter according to claim 1, wherein
the control circuit fixes an on-time of the high-side switch to a predetermined value and adjusts an off-time of the high-side switch, to control output power of the DC-DC converter.
